(19) United States
(12) Patent Application Publication
(10) Pub. No.: US 2008/0142664 A1
(43) Pub. Date: Jun. 19, 2008

(54) SUPPORTS FOR ELECTRONIC DEVICES

(75) Inventors: Chien-Hua SUI, Hualien County (TW); Han-Kuang Ho, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/733,179

(22) Filed: Apr. 9, 2007

(30) Foreign Application Priority Data
Dec. 14, 2006 (TW) 95146835

(51) Int. Cl. A47G 29/00; F16M 13/00

(52) U.S. Cl. 248/371

(57) ABSTRACT

Supports for electronic devices are provided. A support includes a main body situated on a base surface, a longitudinal frame, two rails, and a connection mechanism. The longitudinal frame is disposed at a center of the main body. The rails are formed on opposite sides of the frame. The connection mechanism connects an electronic device and movably connects the rails.

### BACKGROUND OF THE INVENTION

1. Field of the Invention

The invention relates in general to supports and in particular to movable supports for electronic devices.

2. Description of the Related Art

Referring to FIG. 1, a conventional support primarily comprises two holders 101, two guide rails 102 fixed at opposite sides of the holders 101, two sliding members 103 movably connected to the rails 102, and a connection member 104. The connection member 104 connects sliding members 103 and an electronic device, such as an LCD, whereby the electronic device is movable along Z axis.

### BRIEF SUMMARY OF THE INVENTION

Supports for electronic devices are provided. A support includes a main body situated on a base surface, a longitudinal frame, two rails, and a connection mechanism. The longitudinal frame is disposed at a center of the main body. The rails are formed on opposite sides of the frame. The connection mechanism connects an electronic device and movably connects the rails.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional support for an electronic device;

FIG. 2 is a perspective diagram of a support for an electronic device;

FIG. 3 is an exploded diagram of the support in FIG. 2;

FIGS. 4 and 5 are perspective diagrams of a support having a longitudinal frame and rails tilting with respect to a base surface; and

FIG. 6 is a perspective diagram of a support having a curved longitudinal frame.

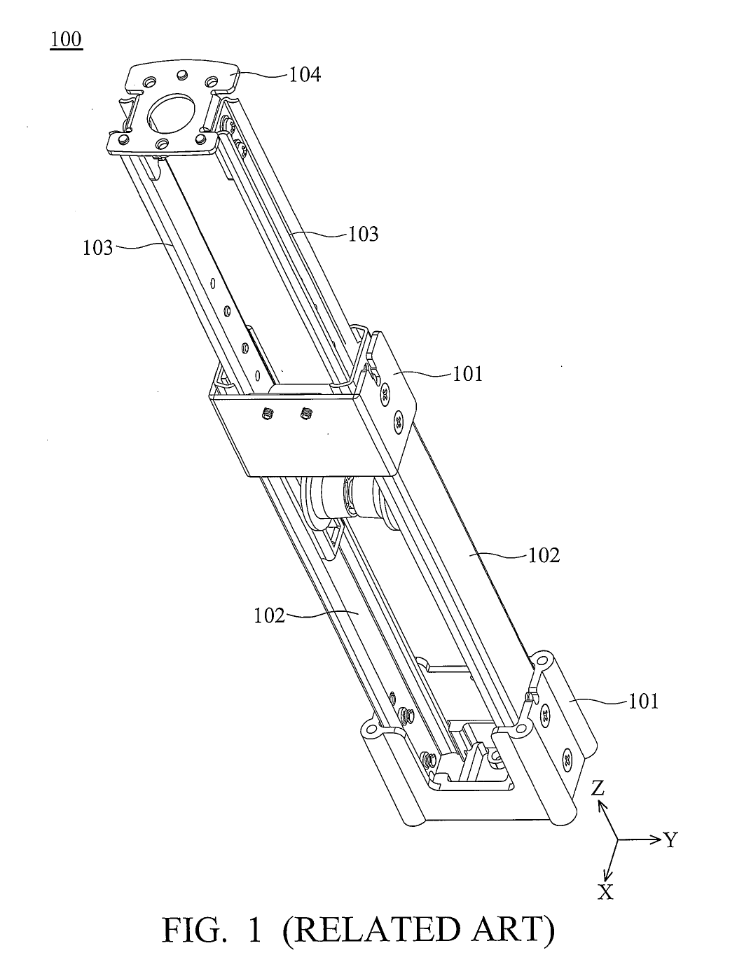

### DETAILED DESCRIPTION OF THE INVENTION

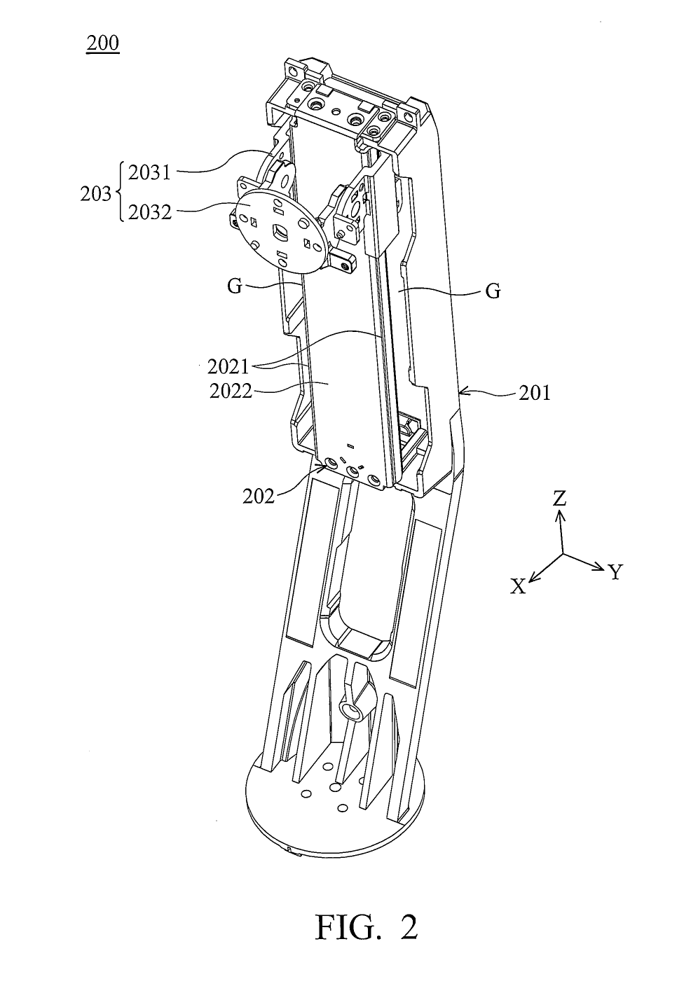

Referring to FIG. 2, an embodiment of a support for an electronic device primarily comprises a main body 201 situated on a base surface, a longitudinal frame 202 fixed to the main body 201, and a connection mechanism 203 connecting the frame 202 and the electronic device, such as an LCD. As shown in FIG. 2, the longitudinal frame 202 is located at the center of the main body 201 and has two guide rails 2021 with the connection mechanism 203 sliding thereon, such that the electronic device is movable along Z axis.

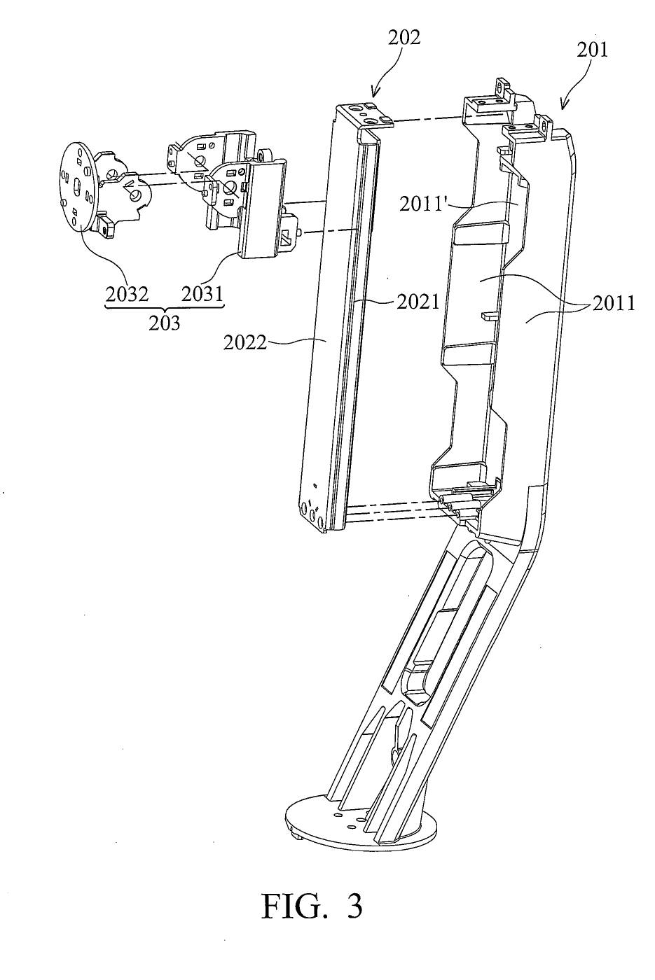

Referring to FIG. 3, the main body 201 is hollow and has two sidewalls 2011 forming an opening 2011′ therebetween. During assembly, the longitudinal frame 202 is received in the opening 2011′, and two slots G are formed between the longitudinal frame 202 and the sidewalls 2011, as shown in FIGS. 2 and 3. In this embodiment, the connection mechanism 203 includes a sliding member 2031 and a connection member 2032 pivotally connected thereto. The electronic device is fixed to the connection member 2032. The sliding member 2031 passes through the slots G and movably connects the rails 2021.

As shown in FIGS. 2 and 3, the longitudinal frame 202 further has a rectangular surface 2022 between the two rails 2022, substantially perpendicular to the sidewalls 2011 and oriented toward the connection mechanism 203 and the electronic device. Here, the longitudinal frame 202 acts as a shield to conceal the opening 2011′, facilitating a clean appearance and safety of usage. Moreover, since the longitudinal frame 202 also acts as a guiding member with the connection mechanism 203 sliding thereon, component number and assembly of the support are simplified.

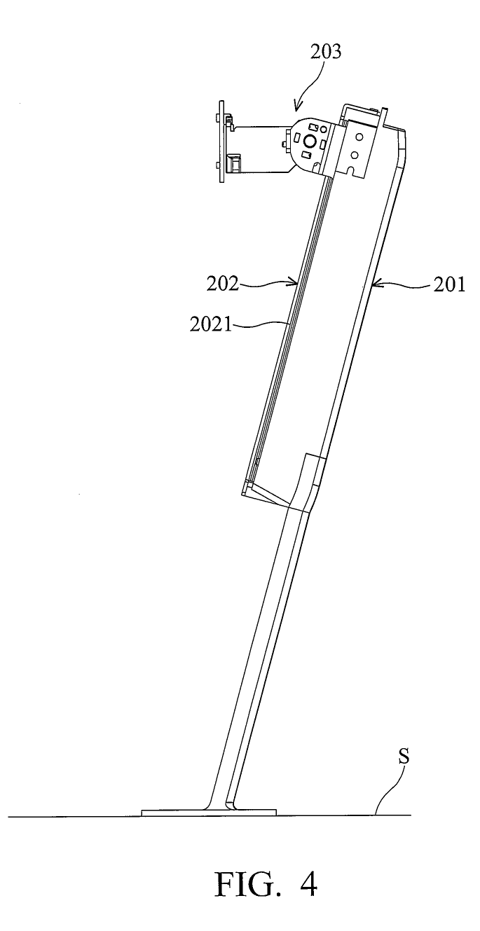

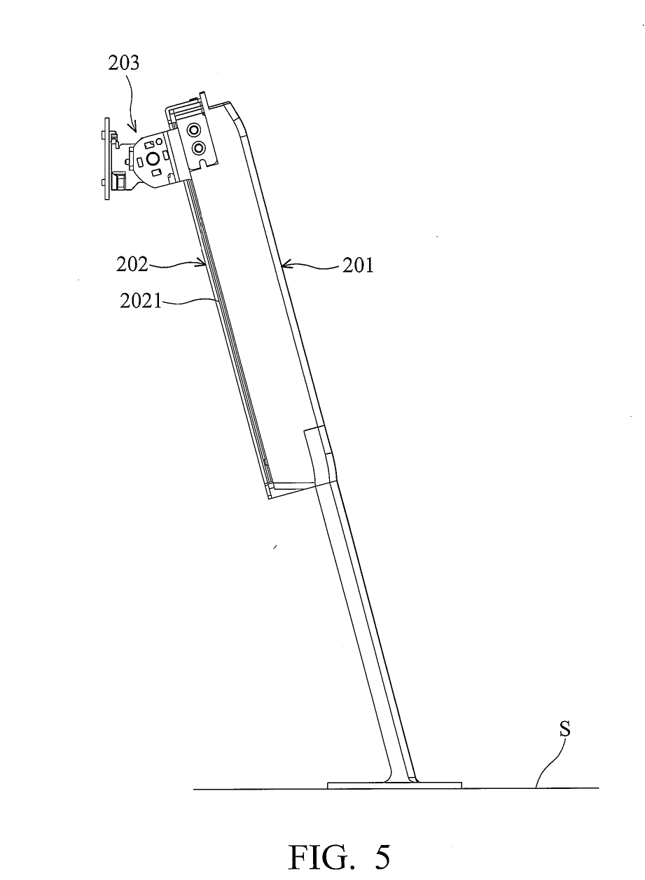

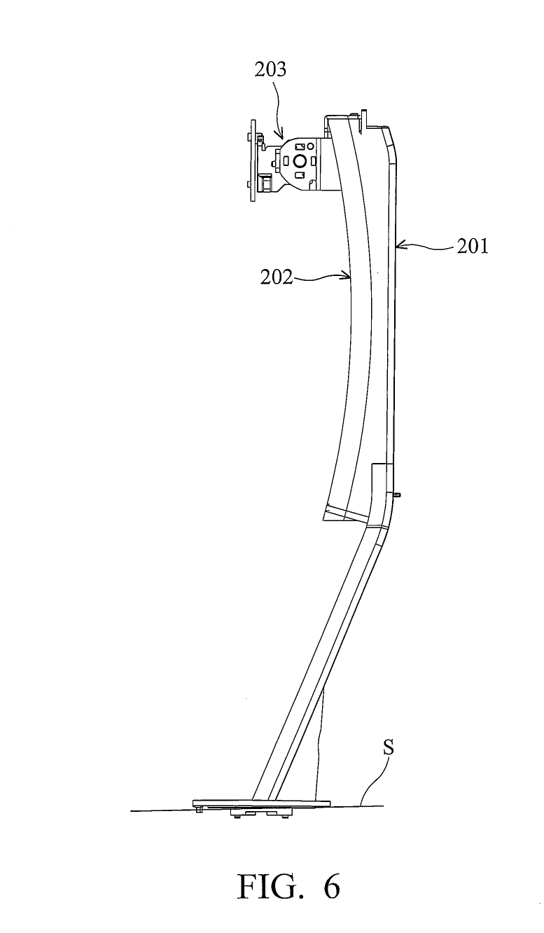

In some embodiments, as shown in FIGS. 4 and 5, the longitudinal frame 202 and the rails 2021 may tilt with respect to the base surface S. In FIG. 6, the longitudinal frame 202 and the rails 2021 may be curved, such that the angle of the electronic device varies during sliding.

Supports for electronic devices are provided according to the embodiments. A support includes a main body and a longitudinal frame disposed at a center thereof, and two rails disposed on opposite sides of the longitudinal frame. The rails can be formed monolithically with the longitudinal frame in one piece, simplifying assembly of the support and reducing production cost.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A support for an electronic device, comprising:
a main body, situated on a base surface;
a longitudinal frame, disposed at a center of the main body;
two rails, formed on opposite sides of the frame; and
a connection mechanism, connecting the electronic device and movably connecting the rails.

2. The support as claimed in claim 1, wherein the connection mechanism comprises a sliding member movably connecting the rails, and a connection member connecting the sliding member and the electronic device.

3. The support as claimed in claim 2, wherein the connection member is pivotally connected to the sliding member.

4. The support as claimed in claim 1, wherein the main body is hollow and has an opening with the frame received therein.

5. The support as claimed in claim 4, wherein the main body comprises two sidewalls with the opening formed therebetween, and the frame and the sidewalls form two slots therebetween.

6. The support as claimed in claim 5, wherein the connection mechanism passes through the slots and movably connects the rails.

7. The support as claimed in claim 5, wherein the frame has a rectangular surface between the rails substantially perpendicular to the sidewalls.

8. The support as claimed in claim 1, wherein the rails are monolithically formed with the frame in one piece.

9. The support as claimed in claim 1, wherein the rails tilt with respect to the base surface.

10. The support as claimed in claim 1, wherein the rails are curved.
